(19) United States
(12) Patent Application Publication
(10) Pub. No.: US 2008/0183497 A1
(43) Pub. Date: Jul. 31, 2008

(54) Method and apparatus for internet-based community of health experts

(76) Inventor: Patrick Soon-Shiong, Los Angeles, CA (US)

Correspondence Address: MORRISON & FOERSTER LLP, 755 PAGE MILL RD, PALO ALTO, CA, 94304-1018, US

(21) Appl. No.: 12/009,952

(22) Filed: Jan. 22, 2008

Related U.S. Application Data
(60) Provisional application No. 60/898,514, filed on Jan. 30, 2007.

(51) Int. Cl. G06Q 50/00

(52) U.S. Cl. 705/2

(57) ABSTRACT

A computer enabled interactive consulting chat room and associated Internet search website with a search engine capability all linked at a single site to address medical questions specific to a medical patient's needs, combined with a consulting room computer enabled interactivity between specialists, treating care-giver, patient and other patients with similar disease are provided. In addition, interactivity with pharmacological innovators of both approved therapies and therapies in development is possible all at that single website. This may be combined with a best practices decision process and a payor authorization capability for instituting such practice.

### CROSS-REFERENCE TO RELATED APPLICATIONS

This application claims priority to U.S. provisional application 60/898,514 filed Jan. 30, 2007 incorporated herein by reference in its entirety.

### BACKGROUND OF THE INVENTION

In the field of medicine, the last decade has seen an explosion of scientific insight into the molecular pathways affecting normal and diseased cells, rapidly translating into molecularly targeted therapeutic options for patients for, e.g., cancer treatment. The era of customized medicine and target-specific therapy has arrived. Increasingly therapeutic choices will be made based on the patient's specific gene profile, the tumor specific over-expression of receptors and the stage of the life-cycle of the disease. With this rapid evolution of both fundamental biology and the rapid translation of this knowledge into clinical medicine there is an increasing need for both patients and their physicians to access real time and objective information upon which to base therapeutic decisions in an evidence-based fashion. With the advent of these next generation technologies both as approved drugs (Herceptin, Avastin, Tykarb, Tarceva, Irressa, Erbitux, Gleevec etc.) and drugs in clinical development, the need for the practicing physician and the patient to access and implement up to date clinical information is now paradoxically greater than when the therapeutic choices were fewer.

These issues are highlighted in the war against cancer. For the past 50 years the armamentarium available to oncologists and cancer patients has been cytotoxic medicines that act in some fashion to poison the cell to stop division and hormonal therapies which deprive cancer cells of steroidal growth factors. In the last decade, an exponential gain has occurred in the knowledge of specific receptors which are over-expressed in tumor cells. Discovery efforts have led to the elucidation of a multitude of receptor types (Her2, MEK, mTOR, FT, SPARC etc) and a network of messenger molecules at the intra-cellular level. All provide targets for next generation therapeutics and currently over 300 molecules (drugs) are under development. The receptors and pathways involved in cancer and its progression are complex. There are multiple intersecting receptors and pathways with cross-talk and interactivity. Of clinical relevance, the receptors present in any one patient differ from those of another patient with the same cancer type. Thus there are “responders” and “non-responders” to any one drug in patients with the same cancer type but with differing molecular profiles, requiring specific treatment and carefully evaluated treatment choices. What is efficacious in one patient may have no effect in another. The knowledge and efficacy specificity is evolving dramatically and represents a major challenge to the practicing clinician to keep abreast of the optimal cocktails of drugs under varying molecular conditions, and clearly almost impossible for the lay patient to maintain state of the art knowledge in the highly technical field of molecular medicine.

This disclosure incorporates by reference in their entireties commonly-invented provisional application No. 60/837,225, filed Aug. 10, 2006; and No. 60/840,292, filed Sep. 14, 2006.

### BRIEF SUMMARY OF THE INVENTION

The need for patients and physicians and scientific leading experts to access a community of global experts relating to an individual patient's care is sorely needed.

This disclosure is directed to an interactive consulting “chat room” and associated Internet search website with a specific search engine capability all linked at a single site to address medical questions specific to a patient's needs, combined with a “consulting room” interactivity between specialists, treating care-giver, patient and other patients with similar disease. In addition, interactivity with pharmacological innovators of both approved therapies and therapies in development is possible all at that single site. This may be combined with a “best practices” decision process and a payor authorization capability for instituting such practice.

From the patient's perspective, the realization that a diagnosis of a life-threatening disease has been made is usually met with a feeling of dread, followed rapidly by the fear of the unknown, followed by a frantic search of identifying the world's leading experts to assist in the providing the best care whether that be in confirming the diagnosis, the treatment plan or the prognosis and alternatives. Today there is no single source in which the patient's specific information can be entered including all aspects of the patient's status including the molecular profile of the patient's condition.

From the physician's perspective, the constant and rapidly changing dynamics of standards of care as modified by the individual patient's molecular status makes it difficult if not impossible for a practicing clinical physician to be continuously aware of new insights into both diagnosis and treatment of a patient with a particular profile. There now exist cancer centers providing prognostic, diagnostic and even predictive biomarkers not available nationally and globally. Treatment decisions based on these biomarkers can significantly affect outcome. Thus an aid to the physician (and to the patient) of which treatment to receive and even more importantly, which treatment not to receive, is needed. A community virtual consulting system in which the patient's case history in a HIPPA (federal patient privacy law) compliant fashion could be posted on the website and responses from outside experts, or patients with same disease, could provide both physician and patient with an interactive “dash-board”.

From the world's leading expert perspective there is a strong desire that their cutting edge, peer reviewed, objective findings be implemented in the clinical world, whether it relates to diagnosis, biomarkers or treatment paradigms. Yet these expert basic scientists or expert clinical scientists do not have a broad platform to disseminate their work to allow both the patient facing a possibly life-threatening disease or his/her practicing physician be made aware of this information. The information may be made available by an updated best practices, live database as well as direct “chat” interaction between patient, physician and expert.

### BRIEF DESCRIPTION OF THE DRAWINGS

FIG. 1 is a block diagram of the present system and method.

### DETAILED DESCRIPTION OF THE INVENTION

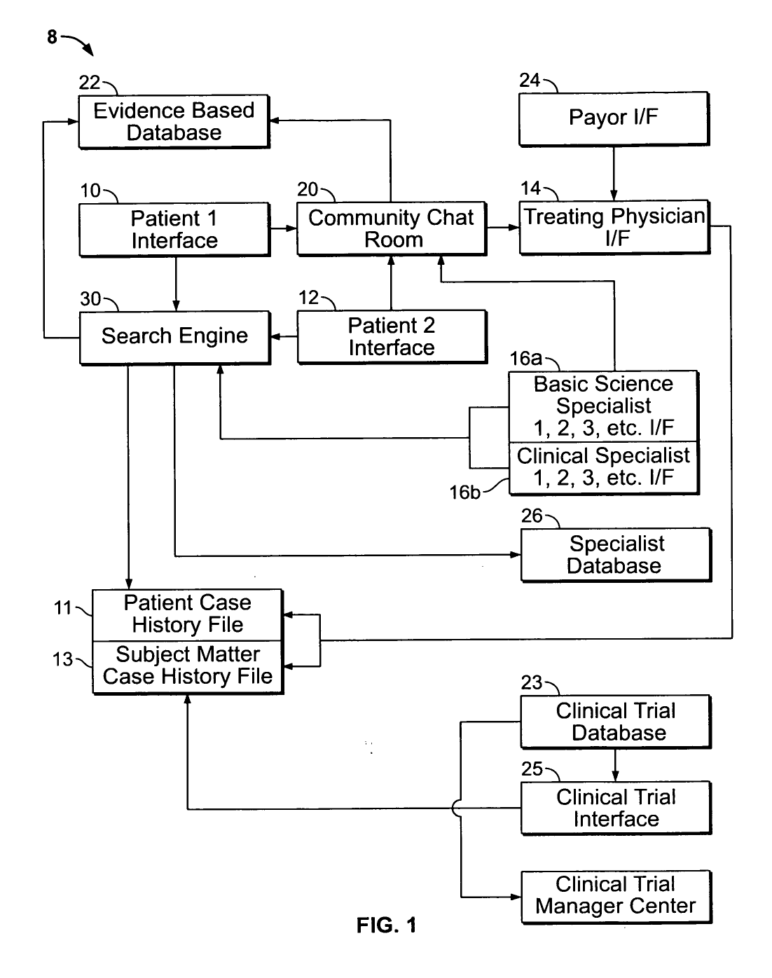

One element in the structure and operation of the present system 8 (see FIG. 1) is the community of interaction between a first patient 1 via associated first patient computer enabled interface 10, patient 2 via associated second patient computer enabled interface 12, a treating physician via associated physician computer enabled interface 14, and medical leading experts such as various basic science specialists 1, 2, 3, etc. via associated computer enabled interface(s) 16a, and various clinical specialists 1, 2, 3, etc. via their associated computer enabled interface(s) 16b interfacing (e.g., via the Internet or other computer network) with centralized evidence based database 22 and specialist database 26 to provide updated evidence based pathway options, inputs from payors via their interface 24, and associated clinical trial data inputs.

The interconnected web-based (i.e. Internet) system 8 and associated community access and store data pertaining to:

Electronic Patient Case History File 11: A computer enabled template designed by practicing physicians allows either the patient or physician to enter data relating to the diagnosis of the patient's condition, including clinical, laboratory and imaging data into this database file (record). A computer enabled search algorithm (engine) 30 detecting key words in the data will immediately link the data input to leading specialists via computer client interfaces 16a, 16b, at the basic science and/or clinical management level. The information regarding these specialists is maintained in associated continuously updated database 26 (conventionally maintained on a host computer server platform) and the patient will have the freedom to communicate with the specialists globally and/or visit directly by identification of the nearest local expert. In a sense this provides a “Yellow Pages” of specialists for that patient's specific condition.

Subject Matter Case History File 13: The Case history file 11 need not be limited to patient data but may include associated file 13 of treatment or diagnostic subject matter in related file (record) 13, for example the results of diagnostic procedures such as MRI, PET Scans, CAT Scans, non-invasive or invasive tests involving all aspects of medical care whether it applies to cardiac disease, neurological disease, cancer, infectious disease, endocrinological disease, GI disease etc. Similarly, subject matter relating to new treatments or families of treatment could be the basis of the case history, e.g., “anti-angiogenic therapies”, hormonal therapies, cytotoxic therapies, drug-eluting stents, etc. The histories could relate to specific products and the trials or new data relating to the drug products, e.g., “Avastin” etc. In essence the web page creates a specific search engine linked at a single site to address the medical questions specific to that patient's needs.

A feature of the system is an additional computer client user interface relating to therapeutic options or interventions relating to the patient's clinical status. For example the combined clinical analysis for a particular patient together with particular biological markers may trigger an automatic drop down menu of best practice pathways. These pathways are generated in a separate, continuously updated database 22 (also referred to as the Evidenced-Based Clinical Pathways). Such pathways are generated by thought leaders and practicing physicians as well as guidelines provided by third part organizations such as NCCN (National Comprehensive Cancer Network) and continuously updated via a database.

Thought Leader Interfaces: Both basic scientist and clinical “thought leaders” provide updated information relating to their field of specialization via interfaces 16a, 16b. Access and dissemination of the information can occur by direct access to the updated databases 22, 26 as well as a community web-based “chat” on line at server-based chat room 20 between treating physician and specialist via a password controlled interaction. This same interaction can occur between patient and patient with a similar condition, as well as patient and specialist.

Clinical Trial Interface 25: Similar to the Evidenced Based Pathway database, a separate continuously updated clinical trial database 23 is interfaced at 25 with the conventional EMR (electronic medical record) and the PMR (patient medical record) which are parts of or linked to Electronic patient case history file 11. A feature of the access to this database 23 via interface 25 is an automatic drop down menu of ongoing trials which covers the patient's current clinical and molecular status. This clinical trial interface is upgradable for electronic data capture of patients who elect to enter into such clinical trials and linked to a centralized Clinical Trial Manager Center 34 (relating to trials of new drugs and therapies) for centralized data capture.

Community Chat Room 20: A community, HIPPA compliant server-based “chat room” discussing the Case History file 11 between treating doctor and consultant thought leader, and between a concerned patient and outside consultants is provided.

Connectivity to Remote Robotic Monitoring Systems: The EMR, PMR and Clinical Trial Interface 25 each have the capability to interface via the Internet with external robotic monitoring and therapeutic (including minimally invasive and surgical procedures) systems currently in development, allowing both remote monitoring of the patient's status as well as remote alerts and prompts for treatment intervention and even for remote management of procedures. Examples of remote technology (not shown) with which interconnectivity is possible include but are not limited to:

Wireless broadband platforms such as Motiva developed by Philips Electronics;

Remote Robotic Healthcare Giver such as the Remote Presence Robot developed by Intouch Health;

Remote Patient Monitoring Devices such as Personal Watcher developed by HomeFree Systems whereby vital signs are monitored via a wearable watch monitor; and

Medication Compliance Monitors such as those in development by Tyco International, Eatn Corp (Home Key System) and Accenture (On-line medicine cabinet).

As will be appreciated, the present system and method rely on conventional and well known techniques in the field of computer science for creating and maintaining databases, operating Internet and Intranet websites, maintaining on-line chat rooms (for a real time exchange of text or other messages amongst a plurality of users), and web-based (Internet) searching and search engines. Hence implementation of the present system is well within the skill of one of ordinary skill in the art, in light of this disclosure.

What is claimed:

1. A computer-implemented method of disseminating information relating to a particular medical patient, comprising the acts of:
providing a first database storing data pertaining to the particular patient;
providing a second database storing data pertaining to medical or scientific specialists;
providing a third database storing data pertaining to clinical medical treatments;
searching at least one of the databases; and
providing a computer network forum for exchanging information among at least two of the particular patient, his physician, and at least one of the specialists, pertaining to the particular patient.

2. The method of claim 1, further comprising providing a search engine to carry out the searching.

3. The method of claim 1, wherein the third database stores data pertaining to best medical practice for treating a plurality of medical conditions.

4. The method of claim 1, further comprising the act of providing a fourth database storing data pertaining to clinical trials of medical treatments.

5. The method of claim 1, wherein the first database stores data pertaining to a treatment profile of the particular patient.

6. A computer program product storing computer code for carrying out the method of claim 1.

7. A programmed computer, programmed to carry out the method of claim 1.

8. Computer based apparatus for disseminating medical information relating to a particular patient, comprising:
a first database storing data pertaining to the particular patient;
a second database storing data pertaining to medical or scientific specialists;
a third database storing data pertaining to clinical medical treatments;
a search engine coupled to search the databases; and
a computer network forum for exchanging information among at least two of the particular patient, his physician, and at least one of the specialists, pertaining to the particular patient.

9. The apparatus of claim 8, further comprising a fourth database storing data pertaining to clinical trials of medical treatments.

10. The apparatus of claim 8, wherein the first database stores data pertaining to a treatment profile of the particular patient.

11. A computer program product storing computer code for carrying out the apparatus of claim 8.
